(19) United States
(12) Patent Application Publication
(10) Pub. No.: US 2012/0006766 A1
(43) Pub. Date: Jan. 12, 2012

(54) SPORTS BOARD LOCKBOX

(76) Inventor: DONALD W. MACKAY, JR., Honolulu, HI (US)

(21) Appl. No.: 13/176,685

(22) Filed: Jul. 5, 2011

Related U.S. Application Data
(60) Provisional application No. 61/344,364, filed on Jul. 6, 2010.

(51) Int. Cl. E05B 73/00

(52) U.S. Cl. 211/4

(57) ABSTRACT

The sports board lockbox provides temporary secure storage for skateboards and/or snowboards. The lockbox includes a back wall with an overhanging roof. A plurality of securing arm pairs and corresponding stabilizing arm pairs extend forwardly from the back wall. Each arm pair defines a sports board-retaining slot. One of the securing arms has a hasp pivotally extending therefrom, the corresponding securing arm having a lock passage therethrough. The sports board is placed in the slots between corresponding securing arms and stabilizing arms, the hasp is closed over the end of the opposite arm, and a padlock is installed through the lock passage of this arm. The skateboard storage configuration may use a generally C-shaped channel as one of the securing arms, with one set of wheels of the skateboard being captured in the channel to prevent their removal when the skateboard is secured in the lockbox.

### CROSS-REFERENCE TO RELATED APPLICATION

This application claims the benefit of U.S. Provisional Patent Application Ser. No. 61/344,364, filed Jul. 6, 2010.

### BACKGROUND OF THE INVENTION

1. Field of the Invention

The present invention relates generally to security devices and systems, and particularly to a sports board lockbox for the temporary security of snowboards, skateboards, and other sports equipment having a board, wherein each individual board is secured by a separate lock operable by the owner of the board.

2. Description of the Related Art

Skateboards have become increasingly popular for short distance personal transportation due to their relative economy and compact dimensions. Skateboards are commonly used by college students on and around campus as an alternative to bicycles to travel reasonably quickly between classrooms in different areas of the campus. An even more common use may be for pure recreation, with a somewhat analogous device, i.e., the snowboard, finding increasing popularity in winter sports.

While skateboards (as well as snowboards) are relatively compact, they are generally too bulky to carry into the classroom due to the lack of storage capacity in the building, particularly when the typical load of books, briefcases, backpacks, and the like often carried by students is considered. As a result, most skateboards (and snowboards, at winter recreational areas) are left outdoors, where they are subject to theft. A high quality skateboard may have a value approaching three hundred dollars, when the cost of the various components (wheel trucks, wheels, bearings, and the board itself) is considered. While bicycle racks are nearly universal on school campuses, those who use skateboards for personal transportation are generally left without secure temporary storage. Another consideration in the case of skateboards is that their loose placement at or near building entrances, sidewalks, etc., results in some hazard to persons walking in the area.

An analogous situation exists with snowboards in winter recreational areas. Snowboards are commonly stuck into a snow bank immediately outside the entrance to a structure, where they are equally prone to theft. Thus, a sports board lockbox solving the aforementioned problems is desired.

### SUMMARY OF THE INVENTION

The sports board lockbox is configured for the temporary secure storage of skateboards, snowboards, and/or some combination thereof. The lockbox includes a back wall providing for attachment to a support structure (wall, pole, bicycle rack, etc.), a sloped roof supported by the back wall, and short end panels. The front and bottom of the lockbox are completely open. Board-securing arm pairs extend forwardly from the back wall, each arm pair defining a board retaining slot therebetween. The forward end of one arm includes a hasp pivotally attached thereto. The forward end of the corresponding arm has a lock shackle passage (e.g., staple, etc.) therethrough or extending therefrom. A pair of stabilizing arms extends forwardly from the back wall, directly below each corresponding pair of securing arms. The sports board is placed in the slots between the securing arms and stabilizing arms, the hasp is swung over the end of the arm having the lock passage therein, and the shackle of a padlock or the like is installed through the lock passage to prevent the hasp from opening. The structure of the board (wheels, ski boot bindings, etc.) prevents the board from passing downward through the securing arms and stabilizing arms.

In one embodiment, the lockbox may include a channel serving as one of the arms of each securing arm pair, the channel serving to capture the wheels of a skateboard therein to prevent their removal from the board. Another embodiment of the lockbox may be configured particularly for the secure storage of snowboards, in which the two arms of each securing arm pair and each stabilizing arm pair comprise bars of round or flat stock. The snowboard is inserted between the two securing arms and corresponding stabilizing arms with at least one of the ski boot bindings being captured between the securing arms and the stabilizing arms to prevent the snowboard from passing downward through the stabilizing arms.

These and other features of the present invention will become readily apparent upon further review of the following specification and drawings.

### BRIEF DESCRIPTION OF THE DRAWINGS

FIG. 1 is an environmental, perspective view of a first embodiment of a sports board lockbox according to the present invention, illustrating the removable placement of a series of sports boards therein.

FIG. 2 is an environmental perspective view of a second embodiment of a sports board lockbox according to the present invention, illustrating an alternative mounting to that shown in FIG. 1.

FIG. 3 is a an environmental perspective view of a third embodiment of a sports board lockbox according to the present invention, illustrating an alternative mounting to that shown in FIGS. 1 and 2.

FIG. 4 is an environmental perspective view of a fourth embodiment of a sports board lockbox according to the present invention, showing an embodiment configured specifically for snowboards.

Similar reference characters denote corresponding features consistently throughout the attached drawings.

### DETAILED DESCRIPTION OF THE PREFERRED EMBODIMENTS

The sports board lockbox provides a semi-enclosed structure having an open front and floor, the structure providing for the secure storage of sports boards, such as skateboards, snowboards, and the like. Each board is individually secured within the lockbox by a separate lock mechanism, which is operable only by a person having the proper key or combination.

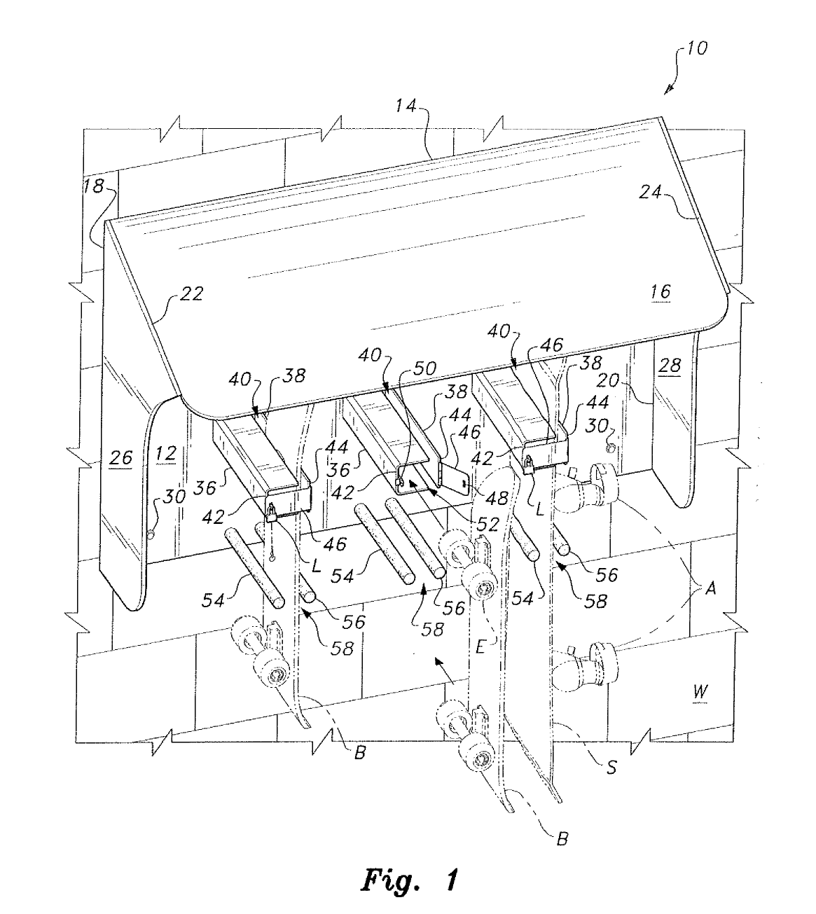

FIG. 1 of the drawings illustrates a first embodiment of the sports board lockbox, comprising a skateboard lockbox 10. The lockbox 10 includes a back wall or panel 12 having an upper edge 14, and a forwardly and downwardly sloping roof panel 16 extending from the upper edge 14 of the back wall 12. The back wall 12 includes mutually opposed first and second lateral edges 18 and 20. The roof 16 has corresponding opposed first and second lateral edges 22 and 24. A first side panel 26 extends between the first lateral edges 18 and 22 of the back wall 12 and roof 16. A second side panel 28 extends between the second lateral edges 20 and 24 of the back wall 12 and roof 16. The front and bottom of the lockbox 10 are open to facilitate access to the interior thereof.

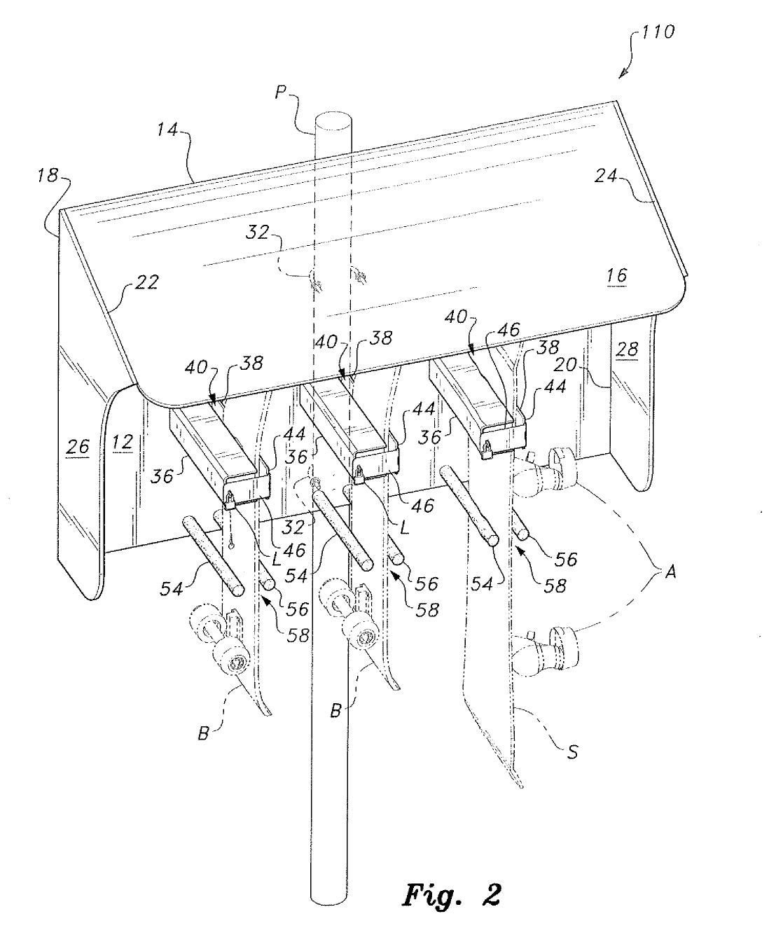

The three embodiments of the lockbox, designated generally as 10, 110, and 210 in FIGS. 1 through 3 of the drawings, differ only in their provision for attachment to a support structure. The sports board lockbox 10 of FIG. 1 includes passages formed through the back wall 12 for the insertion of bolts 30 or other suitable conventional fasteners into appropriate conventional anchors set in a support wall W. The sports board lockbox 110 of FIG. 2 is constructed substantially identical to the lockbox 10 of FIG. 1, i.e., having a back wall 12, roof 16, and first and second side panels 26 and 28, but differs in that it is supported by a generally vertical pole or post P, with conventional U-bolt and nut assemblies 32 (or other suitable attachment hardware) being used to attach the back wall 12 to the post or pole P.

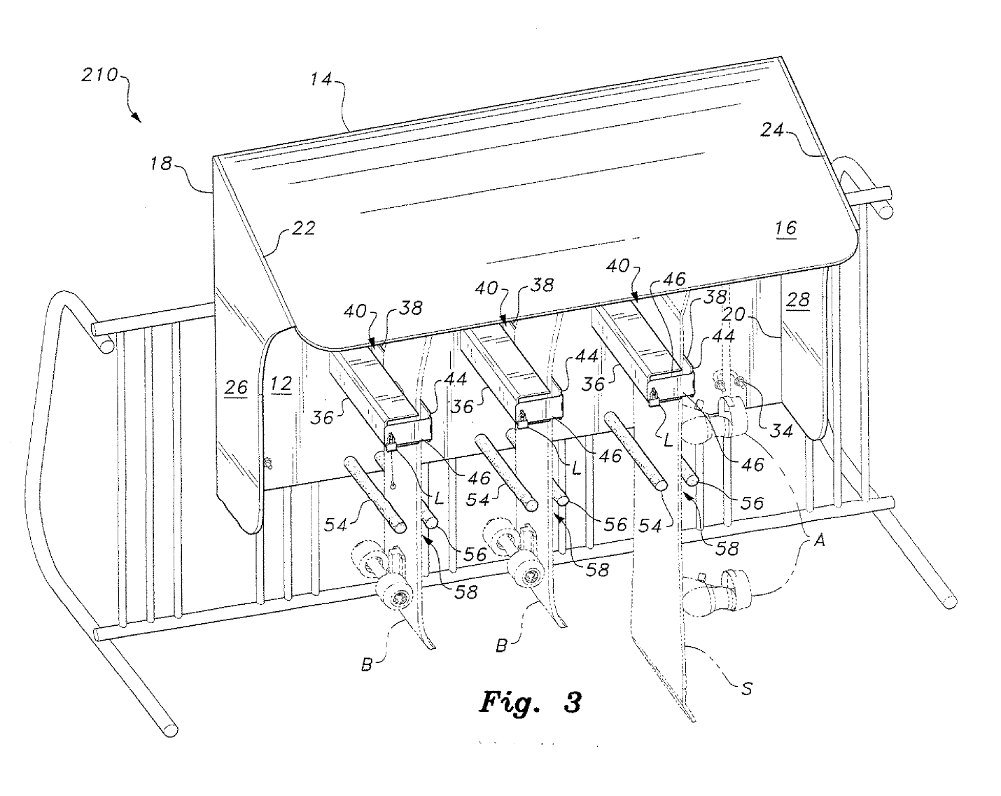

Alternatively, the sports board lockbox may be secured to another storage device of some sort, e.g., the bicycle rack R shown in FIG. 3. The lockbox 210 of FIG. 3 differs from the lockboxes 10 and 110 of FIGS. 1 and 2 only due to its means of attachment to the rack R, e.g., smaller U-bolts or shackles 34 that pass through the back wall 12 of the lockbox 210 and around various ones of the conventional uprights of the cycle rack R. The lockbox 210 is illustrated in FIG. 3 as being relatively close to the bottom of the rack R, but this is primarily for the purpose of illustrating the entire concept clearly on the drawing sheet. It will be understood that the lockbox 210 may be attached to the upper portion of the cycle rack R to allow bicycle wheels to be inserted between the uprights of the rack R beneath the lower edge of the back wall 12 of the lockbox.

The skateboard lockboxes 10, 110, and 210 of FIGS. 1 through 3 each include a plurality of first and second sports board securing arms 36 and 38 extending forwardly from the back wall 12. It should be noted that, while only three pairs of arms 36 and 38 are shown for each of the lockbox embodiments of FIGS. 1 through 4, additional pairs of arms may be provided merely by lengthening the back wall 12 and roof 16 of any of the embodiments and adding additional pairs of arms 36, 38. The relatively few sports board support arm pairs illustrated in each of the drawings is due to the need to provide sufficient detail in each of the drawings.

The two arms 36 and 38 of each pair are spaced apart laterally from one another to define a sports board retaining slot 40 therebetween. Each of the arms 36, 38 has a forward end 42, 44 and a selectively lockable closure extending across to join the forward ends 42, 44 of each pair of arms 36, 38. In the example disclosed herein, the closure comprises a hasp 46 pivotally attached to the forward end 44 of each of the second arms 38 by a hinge. The distal end of each hasp 46 has a slot 48 formed therethrough, as shown clearly in the open second hasp 46 of FIG. 1. The forward end 42 of each of the first arms 36 has a passage 50 therein, e.g., a hole formed through a tongue or tang that passes through the slot 48 in the end of the hasp 46, a staple protruding from the forward end 42 of the first arm 36, etc., as shown on the second of the three first board securing arms 36 of FIG. 1.

Each of the first arms 36 preferably comprises a generally C-shaped cross section to define a channel 52 therein. The open mouth of the channel 52 faces toward the corresponding second arm 38 in each pair, as shown in the open first and second arm pair 36, 38 of FIG. 1. Either the forward or the rearward pair of wheels E of the skateboard B, e.g., the uppermost pair of wheels of the right hand skateboard B of FIG. 1, are inserted into the channel 52 as the skateboard B is passed into the board retaining slot 40 between the first and second arms 36, 38, and the hasp 46 is closed over the lock shackle passage 50 of the forward end 42 of the first arm 36. The shackle of a conventional padlock L or the like (which may be key-operated or a combination lock) is inserted through the passage 50 over the closed hasp 46, and the lock L is locked to retain the skateboard wheels E within the channel 52, thus locking the skateboard B securely within the lockbox 10, as shown in FIGS. 1 through 3.

Additional stability for sports boards secured in the lockbox may be provided by first and second stabilizing arms 54,56, extending from the back wall 12 of the lockbox. The stabilizing arms 54, 56 are positioned below the corresponding first and second board-securing arms 36 and 38. Each set of first and second stabilizing arms 54, 56 define a sports board stabilizing slot 58 therebetween. Thus, a sports board inserted in the stabilizing slot 58 of a pair of stabilizing arms 54, 56 and secured by corresponding first and second securing arms 36, 38 cannot swing in the wind and contact other boards secured within the lockbox. Any or all of the arms 36, 38, 54, and/or 56 may include some form of padding or cushioning thereon to provide further protection for boards secured therein, if desired.

While the embodiments 10, 110, and 210 respectively of FIGS. 1 through 3 are configured particularly for the secure storage of skateboards therein, it will be seen that they may also be used for the storage of snowboards in lieu of, or in addition to, the skateboards, as shown in FIGS. 1 and 2 of the drawings. This depends upon the specific dimensions and spacing of the various lockbox components, as well as the dimensions of the snowboard S and location and spacing of the ski boot bindings A of the snowboard.

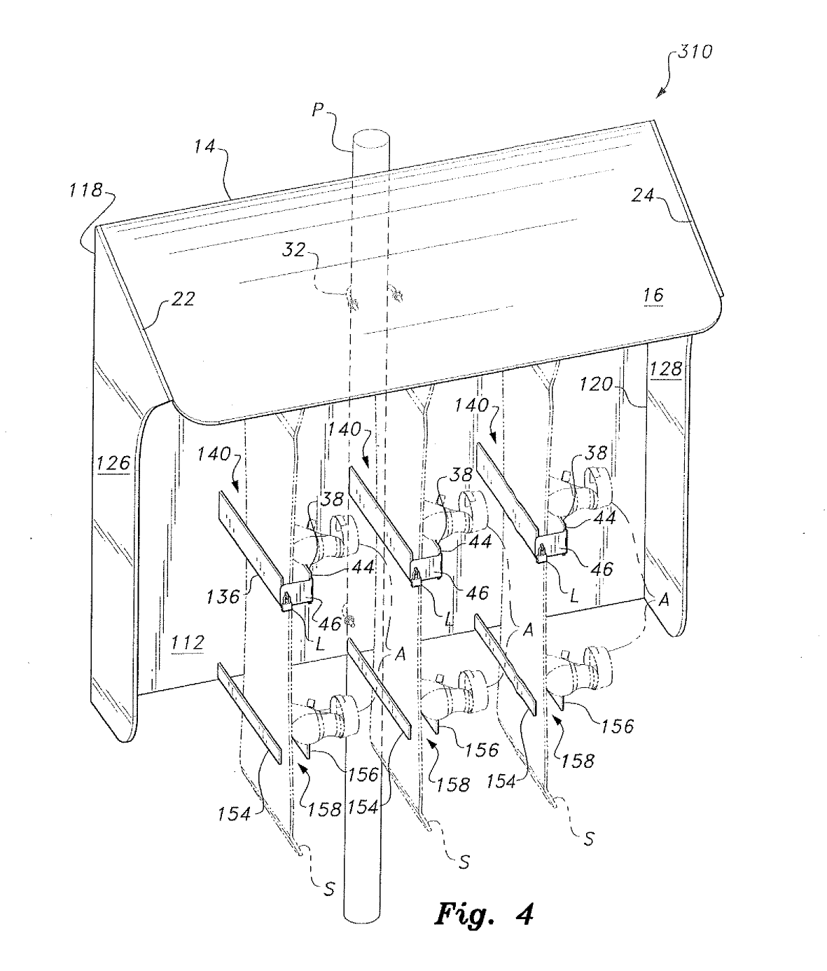

However, the sports board lockbox may be configured specifically for the secure storage of snowboards S, if desired, as shown in FIG. 4 of the drawings. The sports board lockbox 310 of FIG. 4 is constructed generally in the same manner as the lockboxes 10, 110, and 210 of FIGS. 1 through 3, i.e., having a back wall 112, a roof 16, and first and second side panels 126, 128. While the roof 16 is substantially identical to those earlier discussed embodiments, it will be noted that the back wall 112 and side panels 126, 128 are somewhat taller than the corresponding components in the embodiments of FIGS. 1 through 3, and thus are designated as back wall 112 and first and second side panels 126 and 128.

A plurality of first and second board-securing arms 136, 38 and first and second board-stabilizing arms 154, 156 extend forward from the back wall 112. The second board-securing arms 38 are identical to the arms 38 of the lockbox embodiments 10, 110, and 210, i.e., having forward ends 44 with hasps 46 extending therefrom. The hasps selectively link to the opposite first securing arms 136. The first snowboard securing arms 136 may be formed of flat stock or any other suitable material, but they need not include the wheel capturing channels of the first skateboard securing arms 36 of the other lockbox embodiments 10, 110, 210, since there are no wheels to protect on snowboards. Padlocks L or other suitable locks may be used to close the snowboard retaining slots 140 defined between each two snowboard-securing arms 136 and 38.

The lower ends of the snowboards S are restrained from movement by first and second snowboard stabilizing arms 154 and 156, which define stabilizing arm slots 158 between each two arms 154, 156. These arms 154, 156 may be formed identically to those shown in FIGS. 1 through 3 for the lockbox embodiments 10, 110, and 210, i.e., formed of tubular material or round bar stock, but they are shown formed of flat stock in FIG. 4.

The first and second board-securing arms 136, 138 of the snowboard lockbox embodiment 310 are positioned somewhat lower than the skateboard-securing arms 36, 38 of the skateboard lockbox embodiments. This is to provide clearance between the board securing arms 136, 138 and the roof 12 of the structure for the end of the board S with one of the ski boot bindings A, the other binding being positioned between the board-securing arms 136, 138 and the corresponding stabilizing arms 154, 156 therebelow. Thus, the snowboard S cannot be lifted upwardly from the securing arms 136, 138 due to the overlying roof 16. The back wall 112 of the snowboard lockbox 310 may have a somewhat greater height than the back walls 12 of the other embodiments, as noted further above, in order to position the lower stabilizing arms 154, 156 somewhat lower than in those other embodiments. This results in the lower ski boot binding A of the snowboard S being captured between the securing arms 136, 138 and the lower stabilizing arms 154, 156, thus preventing the snowboard S from being removed downward from the lockbox 310. Accordingly, the sports board lockbox provides secure, individually accessible storage for a number of skateboards or snowboards, the specific dimensions of the lockbox being adjusted as required, depending upon the specific types of boards to be secured therein. The basic principles and structure of the security system remain the same for both types of boards.

It is to be understood that the present invention is not limited to the embodiments described above, but encompasses any and all embodiments within the scope of the following claims.

I claim:

1. A sports board lockbox, comprising:
a back wall having an upper edge and mutually opposed first and second lateral edges;
a roof sloping forward and downward from the upper edge of the back wall, the roof having mutually opposed first and second lateral edges;
a plurality of first securing arms extending forward from the back wall, each of the first securing arms having a forward end;
a plurality of second securing arms extending forward from the back wall, each of the second securing arms having a forward end, each of the second securing arms and a corresponding one of the first securing arms defining a sports board retaining slot therebetween; and
a selectively locking closure disposed across the forward ends of the first securing arms and the corresponding one of the second securing arms, each pair of the first and second securing arms having an independently operable locking closure.

2. The sports board lockbox according to claim 1, wherein the closure of the first securing arms and corresponding one of the second securing arms comprises a hasp pivotally extending from the forward end of each of the second securing arms, the hasp having a distal end and a slot defined through the distal end, the forward end of each of the first securing arms having a lock shackle passage therethrough, the slot of the hasp selectively closing over the forward end of the corresponding first securing arm.

3. The sports board lockbox according to claim 1 wherein each of the first securing arms is an elongated channel having an open mouth facing laterally, the open mouth of each of the first securing arms facing the corresponding second securing arm.

4. The sports board lockbox according to claim 1, further comprising:
a plurality of first stabilizing arms extending forward from the back wall, each of the first stabilizing arms being spaced below a corresponding one of the first securing arms;
a plurality of second stabilizing arms extending forward from the back wall, each of the second stabilizing arms being spaced below a corresponding one of the second securing arms, each of the second stabilizing arms and a corresponding one of the first stabilizing arms defining a sports board stabilizing slot therebetween.

5. The sports board lockbox according to claim 1, further comprising mutually opposed first and second side panels respectively disposed between the first and second lateral edges of the back panel and the roof.

6. The sports board lockbox according to claim 1, further comprising at least one pole support attached to the back wall.

7. The sports board lockbox according to claim 1, further comprising at least one rack support attached to the back wall.

8. A sports board lockbox, comprising:
a back wall having an upper edge and mutually opposed first and second lateral edges;
a plurality of first securing arms extending forward from the back wall, each of the first securing arms having a forward end;
a plurality of second securing arms extending forward from the back wall, each of the second securing arms having a forward end, each of the second securing arms and a corresponding one of the first securing arms defining a sports board retaining slot therebetween; and
a hasp pivotally extending from the forward end of each of the second securing arms, the hasp having a distal end and a slot defined through the distal end, the forward end of each of the first securing arms having a lock shackle passage therethrough, the slot of the hasp selectively closing over the forward end of the corresponding first securing arm.

9. The sports board lockbox according to claim 8, further comprising a roof sloping forward and downward from the upper edge of the back wall, the roof having mutually opposed first and second lateral edges.

10. The sports board lockbox according to claim 9, further comprising mutually opposed first and second side panels respectively disposed between the first and second lateral edges of the back panel and the roof.

11. The sports board lockbox according to claim 8 wherein each of the first securing arms is an elongated channel having an open mouth facing laterally, the open mouth of each of the first securing arms facing the corresponding second securing arm.

12. The sports board lockbox according to claim 8, further comprising:
a plurality of first stabilizing arms extending forward from the back wall, each of the first stabilizing arms being spaced below a corresponding one of the first securing arms;
a plurality of second stabilizing arms extending forward from the back wall, each of the second stabilizing arms being spaced below a corresponding one of the second securing arms, each of the second stabilizing arms and a corresponding one of the first stabilizing arms defining a sports board stabilizing slot therebetween.

13. The sports board lockbox according to claim 8, further comprising at least one pole support attached to the back wall.

14. The sports board lockbox according to claim 8, further comprising at least one rack support attached to the back wall.

15. A sports board lockbox, comprising:
a back wall having an upper edge;
a plurality of first securing arms extending forward from the back wall, each of the first securing arms having a forward end, each of the first securing arms being an elongated channel having an open mouth facing laterally;
a plurality of second securing arms extending forward from the back wall, each of the second securing arms having a forward end, each of the second securing arms and a corresponding one of the first securing arms defining a sports board retaining slot therebetween, the open mouth of each of the first securing arms facing the corresponding second securing arm; and
a selectively locking closure disposed across the forward ends of the first securing arms and the corresponding one of the second securing arms, each pair of the first and second securing arms having an independently operable locking closure.

16. The sports board lockbox according to claim 15, further comprising a roof sloping forward and downward from the upper edge of the back wall, the roof having mutually opposed first and second lateral edges.

17. The sports board lockbox according to claim 16, further comprising mutually opposed first and second side panels respectively disposed between the first and second lateral edges of the back panel and the roof.

18. The sports board lockbox according to claim 15, wherein the closure of each of the first securing arms and corresponding one of the second securing arms comprises a hasp pivotally extending from the forward end of each of the second securing arms, the hasp having a distal end and a slot defined through the distal end, the forward end of each of the first securing arms having a lock shackle passage therethrough, the slot of the hasp selectively closing over the forward end of the corresponding first securing arm.

19. The sports board lockbox according to claim 15, further comprising:
a plurality of first stabilizing arms extending forward from the back wall, each of the first stabilizing arms being spaced below a corresponding one of the first securing arms;
a plurality of second stabilizing arms extending forward from the back wall, each of the second stabilizing arms being spaced below a corresponding one of the second securing arms, each of the second stabilizing arms and a corresponding one of the first stabilizing arms defining a sports board stabilizing slot therebetween.

20. The sports board lockbox according to claim 15, further comprising at least one support attached to the back wall, the support being selected from the group consisting of pole supports and rack supports.
